(19) United States
(12) Patent Application Publication
(10) Pub. No.: US 2021/0064798 A1
(43) Pub. Date: Mar. 4, 2021

(54) POWER SYSTEM RELIABILITY ASSESSMENT METHOD CONSIDERING OPTIMIZED SCHEDULING OF CASCADE HYDROPOWER STATIONS

(71) Applicant: Chongqing University, Chongqing (CN)

(72) Inventors: Bo Hu, Chongqing (CN); Kaigui Xie, Chongqing (CN); Ye Li, Chongqing (CN); Tao Niu, Chongqing (CN); Wei Chen, Chongqing (CN); Weixin Zhang, Chongqing (CN)

(21) Appl. No.: 16/987,258

(22) Filed: Aug. 6, 2020

(30) Foreign Application Priority Data
Aug. 26, 2019 (CN) 201910791182.1

(51) Int. Cl. G06F 30/20; G06Q 10/04; G06Q 10/06; G06Q 50/06; G06N 20/00; G06N 7/00

(52) U.S. Cl. CPC G06F 30/20; G06Q 10/04; G06Q 10/06312; G06F 2111/10; G06Q 50/06; G06N 20/00; G06N 7/005; G06Q 10/067

(57) ABSTRACT

The present invention discloses a power system reliability assessment method considering optimized scheduling of cascade hydropower stations, by which the reliability of the power system is improved, comprising following steps: establishing power system optimization models; inputting the sequential wind speed, runoff and load data within 24h; in accordance with reliability parameters of units and by the sequential Monte Carlo method, sampling the state durations of three kinds of units and segmenting the state durations on a 24-hour cycle; calculating the sequential output of wind farms within 24h according to wind speed data and the state of wind power units; calculating the hourly loss-of-load, according to the state of wind power units and thermal power units as well as the optimization models; optimizing for 365 days according to the method described in the step 4, and calculating reliability indices; and determining convergence or not, and if not, continuously repeating the steps S3 to S7 until convergence.

### CROSS-REFERENCE TO RELATED PATENT APPLICATION

This application claims priority to and the benefit of CN 201910791182.1, filed Aug. 26, 2019, entitled “POWER SYSTEM RELIABILITY ASSESSMENT METHOD CONSIDERING OPTIMIZED SCHEDULING OF CASCADE HYDROPOWER STATIONS,” by Bo Hu et al. The entire disclosure of the above-identified application is incorporated herein by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### FIELD OF THE PRESENT INVENTION

The present invention relates to the field of power system reliability assessment and in particular to a power system reliability assessment method considering optimized scheduling of cascade hydropower stations.

### BACKGROUND OF THE PRESENT INVENTION

At present, there are few researches on the reliability of power systems with cascade hydropower stations both in China and abroad. Moreover, in the existing reliability assessment methods for cascade hydropower stations, when determining the output of cascade hydropower stations, only the utilization of water resources within the current period is considered, the reservoirs are not fully used to optimize the utilization of water resources in multiple periods, and no attention is paid to the coordinated operation between the cascade power stations.

Optimized scheduling of cascade hydropower stations can coordinate the output between the power stations while maximizing the utilization of water resources. This can increase the power generation capacity of the systems and improve the reliability of the systems. Meanwhile, the optimized scheduling of cascade hydropower stations is a multi-stage decision making process. The decisions made within periods are restricted by and related to each other. The solution to this problem has challenges such as high system dimension and coupling constraint. Therefore, when assessing the reliability of power systems mainly based on cascade hydropower stations, it is necessary to take the optimized scheduling of the cascade hydropower stations into account.

Therefore, a heretofore unaddressed need exists in the art to address the aforementioned deficiencies and inadequacies.

### SUMMARY OF THE PRESENT INVENTION

In view of deficiencies of the prior art, the present invention provides a power system reliability assessment method considering optimized scheduling of cascade hydropower stations. In the present invention, the impact of the optimized scheduling of cascade hydropower stations on the reliability of systems is taken into full consideration. The reliability of systems can be improved by the optimized scheduling of cascade hydropower stations.

For this purpose, the present invention employs the following technical solutions.

A power system reliability assessment method considering optimized scheduling of cascade hydropower stations is provided, by which the reliability of the power system is improved, comprising following steps:

S 1: establishing wind, thermal and hydropower power system optimization models considering short-term optimized scheduling of the cascade hydropower stations, and calculating by a central processing unit:

S1.1: establishing an output model for the cascade hydropower stations:

(a) output function for the hydropower stations:

P_{i,t}=KᵢQ_{i,t}Hᵢ (1.1)

where, Kᵢ represents an output coefficient from the i^{th}-stage hydropower station; Q_{i,t} represents the power flow of the i^{th}-stage hydropower station at the t^{th} hour; and Hᵢ represents the head of the i^{th}-stage hydropower station, which is measured by a water level meter;

(b) output constraint for the hydropower stations:

P_{i, min}≤P_{i,t} ≤P_{i, max} (1.2)

where, P_{i,max} and P_{i,min} represent maximum and minimal outputs of the i^{th}-stage hydropower station;

(c) power flow constraint:

Q_{i,min}≤Q_{i,t}≤Q_{i,max} (1.3)

where, Q_{i,max} and Q_{i,mi} represent maximum and minimal power flows of the i^{th}-stage hydropower station;

(d) water balance constraint:

V_{i,t}=V_{i,t-1}+(I_{i,t}+Q_{i-1,t}+S_{i-1,t}−Q_{i,t}−S_{i,t})×Δt (1.4)

where, V _{i,t} represents the storage capacity of the i^{th}-stage hydropower station at the t^{th}-stage hour; O_{i,t} represents the runoff into the reservoir of the i^{th}-stage hydropower station at the t^{th} hour, which is measured by a flowmeter; S_{i,t} represents the spillage flow of the i^{th}-stage hydropower station at the t^{th} hour; Δt=3600 seconds;

(e) discharge flow constraint:

D_{i,min}≤S_{i,t}+Q_{i,t}≤D_{i,max} (1.5)

where, D_{i,max} and D_{i,min} represent maximum and minimal discharge flows allowable by the i^{th}-stage hydropower station;

(f) storage capacity constraint:

V_{i,min}≤V_{i,t}≤V_{i,max} (1.6)

where, V_{i,max} and V_{i,min} represent maximum and minimal storage capacities of the i^{th}-stage hydropower station;

(g) storage capacity equalization constraint at the beginning and ending of the scheduling cycle:

V,_{i,0}=V_{i,T} (1.7)

where, V_{i,0} and V_{i,T} represent storage capacities of the i^{th}-stage hydropower station at the beginning and ending of the scheduling cycle;

S1.2: output model for wind farms:

based on the principle of aerodynamics, the output power of the wind power units is in direct proportion to the third power of wind speed, then:

$$P ( v ) = \{ \begin{matrix}0 & ( v \leq {v}_{ci} ) ⋃ ( v \geq {v}_{co} ) \\ \frac{{P}_{R}}{{v}_{R}^{3} - {v}_{ci}^{3}} ( {v}^{3} - {v}_{ci}^{3} ) & {v}_{ci} \leq v \leq {v}_{R} \\ {P}_{R} & {v}_{R} \leq v \leq {v}_{co}\end{matrix} \qquad ( 1.8 )$$

where, P(v) represents the output power of the wind power units; P_{R} represents the rated power of the wind power units; v_{ci}, represents the cut-in wind speed; V_{R} represents the rated wind speed; v_{co} represents the cut-out wind speed; and v represents the wind speed at high points on hubs of the wind power units, which is measured by a wind meter;

without considering the wake effect and the wind speed correlation in the wind farms, the output of the wind farms is the sum of output power of the wind power units:

$$W P ( v ) = {\sum }_{i = 1}^{{N}_{w g}} {α}_{i} {P}_{i} ( v ) \qquad ( 1.9 )$$

where, WP(v) represents the output of the wind farms; N_{wg} represents the number of wind power units; and αᵢ represents the state of the wind power units, indicating the normal operation of the wind power units at αᵢ=1 and the fault of the wind power units at αᵢ=0;

S1.3: output model for the thermal power units:

TP_{j,min}≤TP_{j,t}≤TP_{j,max} (1.10)

where, TP_{i,max} and TP_{j,min} represent maximum and minimal outputs of the thermal power unit j;

−rⱼ^{d}≤TP_{j,t}−TP_{j,t-1}≤rⱼ^{u} (1.11)

where, and rⱼ^{u} and rⱼ^{d} represent maximum ramp-ups and ramp-downs rates of the thermal power unit j;

S1.4: Optimized operation models for wind, thermal and hydropower power systems:

establishing an objective function to minimize the amount of load shed:

$$min f = {\sum }_{t = 1}^{T} {LoL}_{t} \qquad ( 1.12 )$$

where, LoLₜ represents the amount of load shed at the t^{th} hour; and T represents the scheduling period, T=24h;

(h) loss-of-load constraint:

0≤LoLₜ≤Lₜ (1.13)

where, Lₜ represents load at the t^{th} hour, which is obtained by a load monitoring system;

(i) power balance constraint:

$${\sum }_{i = 1}^{{N}_{H}} {P}_{i , t} + {\sum }_{j = 1}^{{N}_{T}} {TP}_{j , t} + {\sum }_{k = 1}^{{N}_{W}} {WP}_{k , t} = {L}_{t} + {LoL}_{t} \qquad ( 1.14 )$$

where, N_{H}, N_{T} and N_{w} represent the number of stages of cascade hydropower stations, the number of thermal power units and the number of wind farms, respectively; TP_{j,t} represents the output of the thermal power unit j at the t^{th} hour; and WP_{k,t} represents the output of the wind farm k at the t^{th} hour;

S2: monitoring the annual wind speed, runoff and load data by the wind meter, the flowmeter and the load monitoring system, and inputting the sequential wind speed, runoff and load data within 24 h;

S3: in accordance with reliability parameters of the wind power units, thermal power units and hydropower units and by the sequential Monte Carlo method, sampling the state durations of the three kinds of units and segmenting the state durations on a 24-hour cycle;

S4: calculating the sequential output of the wind farms within 24 h according to the wind speed data and the state of the wind power units;

S5: calculating, by the central processing unit, the sequential output of the cascade hydropower stations and the thermal power units with 24 h and the hourly loss-of-load, according to the state of the wind power units and the thermal power units as well as the wind, thermal and hydropower power system optimization models considering short-term optimized scheduling of the cascade hydropower stations;

S6: optimizing for 365 days according to the method described in the step S5, and calculating yearly reliability indices: loss-of-load expectation LOLE, loss-of-energy expectation LOEE and loss-of-load frequency LOLF; and

S7: determining convergence or not according to the following equation, i.e., determining whether a coefficient of variance δ is less than or equal to a set value, and if not, returning to the step S3 and repeating the steps S3 to S7 until convergence:

$$δ = \frac{s t d ( L O E E )}{\sqrt{{N}_{s}} \times mean ( LOE E )} \qquad ( 1.15 )$$

where, std(LOEE) and mean(LOEE) represent standard deviation and mean of LOEE; and Nₛ represents the number of simulated years.

Further, in the step S1.2, when the wind speed v is between V_{ci} and V_{R}, the output power of the wind power units can be approximately linear to the wind speed:

$$P ( v ) = \{ \begin{matrix}0 & ( v \leq {v}_{ci} ) ⋃ ( v \geq {v}_{co} ) \\ {P}_{R} \frac{v - {v}_{co}}{{v}_{R} - {v}_{ci}} & {v}_{ci} \leq v \leq {v}_{R} \\ {P}_{R} & {v}_{R} \leq v \leq {v}_{co}\end{matrix} \qquad ( 1.16 )$$

The present invention has the following beneficial effects: the impact of the optimized scheduling of cascade hydropower stations on the reliability of power systems is taken into full consideration, and by assessing the reliability of wind, thermal and hydropower power systems considering optimized scheduling of cascade hydropower stations, the reliability of the systems can be improved.

### BRIEF DESCRIPTION OF THE DRAWINGS

FIG. 1 is a curve of power characteristics of asynchronous wind power units; and

FIG. 2 is a flowchart of the present invention.

FIG. 3 shows wind turbine parameters with a first table.

FIG. 4 is a table showing thermal power unit parameters.

FIG. 5 is a table showing cascade hydropower stations parameters with a third table.

FIG. 6 is a diagram showing sequential load changing with time.

FIG. 7 is a table showing monthly maximum load (MW).

FIG. 8 is a table showing the relationship between the water level and the storage capacity.

FIG. 9 is a table showing the impact of optimal dispatching on the reliability.

### DETAILED DESCRIPTION

The present invention will now be described more fully hereinafter with reference to the accompanying drawings, in which exemplary embodiments of the present invention are shown. The present invention may, however, be embodied in many different forms and should not be construed as limited to the embodiments set forth herein. Rather, these embodiments are provided so that this disclosure is thorough and complete, and will fully convey the scope of the invention to those skilled in the art. Like reference numerals refer to like elements throughout.

The present invention will be further described below in detail with reference to the accompanying drawings and by specific embodiments.

A power system reliability assessment method considering optimized scheduling of cascade hydropower stations, as shown in FIG. 2, comprises following steps:

S 1: Wind, thermal and hydropower power system optimization models considering short-term optimized scheduling of the cascade hydropower stations are established, and calculated by a central processing unit.

S1.1: Output model for the cascade hydropower stations:

(a) Output function for the hydropower stations:

P_{i,t}=KᵢQ_{i,t}Hᵢ (2.1)

where, Kᵢ represents an output coefficient from the i^{t}-stage hydropower station; Q_{i,t}, represents the power flow of the i^{th}-stage hydropower station at the t^{th} hour; and Hᵢ represents the head of the i^{th}-stage hydropower station.

(b) Output constraint for the hydropower stations:

P_{i,min}≤P_{i,t}≤P_{i,max} (2.2)

where, P_{i,max} and P_{i,min} represent maximum and minimal outputs of the i^{th}-stage hydropower station.

(c) Power flow constraint:

Q_{i,min}≤Q_{i,t}≤Q_{i,max} (2.3)

where, Q_{i,max} Q_{i,mi} and represent maximum and minimal power flows of the i^{th}-stage hydropower station.

(d) Water balance constraint:

V_{i,t}=V_{i,t-1}+(I_{i,t}+Q_{i-1,t}+S_{i-1,t}−Q_{i,t}−S_{i,t})×Δt (2.4)

where, V_{i,t} represents the storage capacity of the i^{th}-stage hydropower station at the t^{th}-stage hour; I_{i,t} represents the runoff into the reservoir of the i^{th}-stage hydropower station at the t^{th} hour, which is measured by a flowmeter; S_{i,t} represents the spillage flow of the i^{th}-stage hydropower station at the t^{th} hour; Δt=3600 seconds.

(e) Discharge flow constraint:

D_{i,min}≤S_{i,t}+Q_{i,t}≤D_{i,max} (2.5)

where, D_{i,max} and D_{i,min} represent maximum and minimal discharge flows allowable by the i^{th}-stage hydropower station.

(f) Storage capacity constraint:

V_{i,min}≤_{i,t}≤V_{i,max} (2.6)

where, V_{i,max} and V_{i,min} represent maximum and minimal storage capacities of the i^{th}-stage hydropower station.

(g) Storage capacity equalization constraint at the beginning and ending of the scheduling cycle:

V_{i,0}=V_{i,T} (2.7)

where, V_{i,0} and V_{i,T} represent storage capacities of the i^{t}-stage hydropower station at the beginning and ending of the scheduling cycle.

Since the short-term optimized scheduling of cascade hydropower stations that use a mode of determining power output by flow is taken into account in the present invention, there is the constraint (2.7). This constraint can not only connect adjacent scheduling cycles, but also ensure the sustainable operation of the cascade hydropower stations and prevent other functions of the cascade hydropower stations from being affected by power generation.

Together with the water balance constraint (2.4), it can be known that, during a one-day scheduling cycle, all the water flowing into the reservoir is used for power generation, and only in two situations, spillage will occur, i.e.: 1) all the inflowing water used for power generation exceeds the demands by load; and 2) each hydropower station generates power according to the maximum power generation capacity, and the water consumption for power generation is less than the amount of inflowing water in the scheduling cycle. This second situation mainly occurs in the flood season. Through the above two constraints, the maximum utilization of water resources is basically achieved.

S1.2: Output model for wind farms:

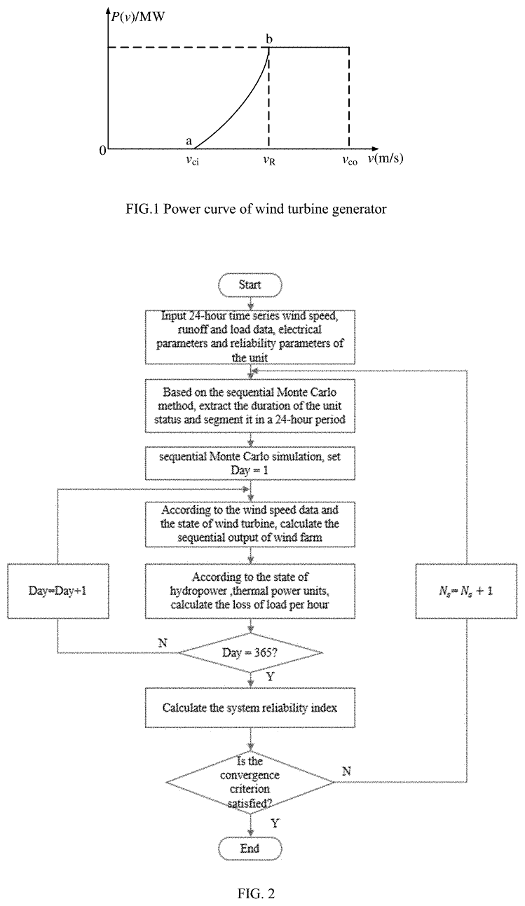

The relationship between the output power of the wind power units and the wind speed is called the power characteristics of the wind power units. Wind power units of different types have different power characteristics, which are mainly determined by the cut-in wind speed, the cut-out wind speed and the rated wind speed. FIG. 1 is a curve of power characteristics of asynchronous wind power units.

Based on the principle of aerodynamics, the output power of the wind power units is in direct proportion to the third power of wind speed, then:

$$P ( v ) = \{ \begin{matrix}0 & ( v \leq {v}_{ci} ) ⋃ ( v \geq {v}_{co} ) \\ \frac{{P}_{R}}{{v}_{R}^{3} - {v}_{ci}^{3}} ( {v}^{3} - {v}_{ci}^{3} ) & {v}_{ci} \leq v \leq {v}_{R} \\ {P}_{R} & {v}_{R} \leq v \leq {v}_{co}\end{matrix} \qquad ( 2.8 )$$

where, P(v) represents the output power of the wind power units; P_{R} represents the rated power of the wind power units; v_{ci} represents the cut-in wind speed; v_{R} represents the rated wind speed; v_{co} represents the cut-out wind speed; and v represents the wind speed at high points on hubs of the wind power units, which is measured by a wind meter.

Generally, when the wind speed v is between V_{ci} and V_{R}, the output power of the wind power units can be approximately linear to the wind speed:

$$P ( v ) = \{ \begin{matrix}0 & ( v \leq {v}_{ci} ) ⋃ ( v \geq {v}_{co} ) \\ {P}_{R} \frac{v - {v}_{co}}{{v}_{R} - {v}_{ci}} & {v}_{ci} \leq v \leq {v}_{R} \\ {P}_{R} & {v}_{R} \leq v \leq {v}_{co}\end{matrix} \qquad ( 2.9 )$$

without considering the wake effect and the wind speed correlation in the wind farms, the output of the wind farms is the sum of output power of the wind power units:

$$W P ( v ) = {\sum }_{i = 1}^{{N}_{w g}} {α}_{i} {P}_{i} ( v ) \qquad ( 2.10 )$$

where, WP(v) represents the output of the wind farms; N_{wg} represents the number of wind power units; and a, represents the state of the wind power units, indicating the normal operation of the wind power units at αᵢ =1 and the fault of the wind power units at αᵢ=0.

S1.3: Output model for the thermal power units:

TP_{j,min}≤TP_{j,t}≤TP_{j,max} (2.11)

where, TP_{j,max} and TP_{j,min} represent maximum and minimal outputs of the thermal power unit j.

−rⱼ^{d}≤TP_{j,t}−TP_{j,t}≤rⱼ^{u} (2.12)

where, rⱼ^{u} and rⱼ^{d} represent maximum ramp-ups and ramp-downs rates of the thermal power unit j.

S1.4: Together with the output model for the cascade hydropower stations, the output model for wind farms and the output model for the thermal power units, optimized operation models for wind, thermal and hydropower power systems will be established below:

an objective function is established to minimize the amount of load shed:

$$min f = {\sum }_{t = 1}^{T} {LoL}_{t} \qquad ( 2.13 )$$

where, LoLₜ represents the amount of load shed at the t^{th} hour; and T represents the scheduling period, T=24 h.

Loss-of-load constraint:

0≤LoLₜ≤Lₜ (2.14)

where, Lₜ represents load at the t^{th} hour, which is obtained by a load monitoring system.

Power balance constraint:

$${\sum }_{i = 1}^{{N}_{H}} {P}_{i , t} + {\sum }_{j = 1}^{{N}_{T}} {TP}_{j , t} + {\sum }_{k = 1}^{{N}_{W}} {WP}_{k , t} = {L}_{t} + {LoL}_{t} \qquad ( 2.15 )$$

where, N_{H}, N_{T} and N_{W} represent the number of stages of cascade hydropower stations, the number of thermal power units and the number of wind farms, respectively; TP_{j,t} represents the output of the thermal power unit j at the t^{th} hour; and WP_{k,t} represents the output of the wind farm k at the t^{th} hour.

S2: The annual wind speed, runoff and load data are monitored by the wind meter, the flowmeter and the load monitoring system, and the sequential wind speed, runoff and load data within 24 h is input.

S3: In accordance with reliability parameters of the wind power units, thermal power units and hydropower units and by the sequential Monte Carlo method, the state durations of the three kinds of units is sampled and segmented on a 24-hour cycle.

S4: The sequential output of the wind farms within 24h is calculated according to the wind speed data and the state of the wind power units.

S5: The sequential output of the cascade hydropower stations and the thermal power units with 24 h and the hourly loss-of-load are calculated by the central processing unit, according to the state of the wind power units and the thermal power units as well as the wind, thermal and hydropower power system optimization models considering short-term optimized scheduling of the cascade hydropower stations.

S6: Optimization is performed for 365 days according to the method described in the step 5, and yearly reliability indices are calculated: LOLE, LOEE and LOLF.

S7: Convergence or not is determined, i.e., whether a coefficient of variance δ is less than or equal to a set value is determined. If not, the steps S3 to S7 are repeated continuously until convergence.

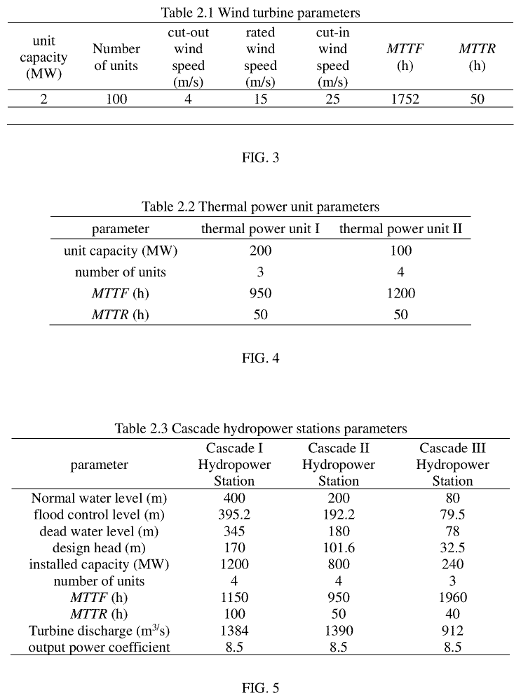

In an embodiment of the present invention, a certain wind, thermal and hydropower power system is taken as an example for analysis. In this system, the cascade hydropower station is a three-stage cascade hydropower station in a tributary of the Yangtze River. This valley is in the rainy season from May to September, in the dry season from December to February in the next year, and in the normal season in the remaining months. FIGS. 3 and 5 show the parameters of wind and thermal power units and the parameters of cascade hydropower stations.

It can be known from FIG. 3 to FIG. 5 that the system is a power system mainly based on cascade hydropower stations. The total installed capacity of the system is 3440 MW; the installed capacity of the cascade hydropower stations is 2240 MW, accounting for about 65%; the installed capacity of thermal power stations is 1000 MW, accounting for about 29%; and the installed capacity of wind power stations is 200 MW, accounting for about 6%.

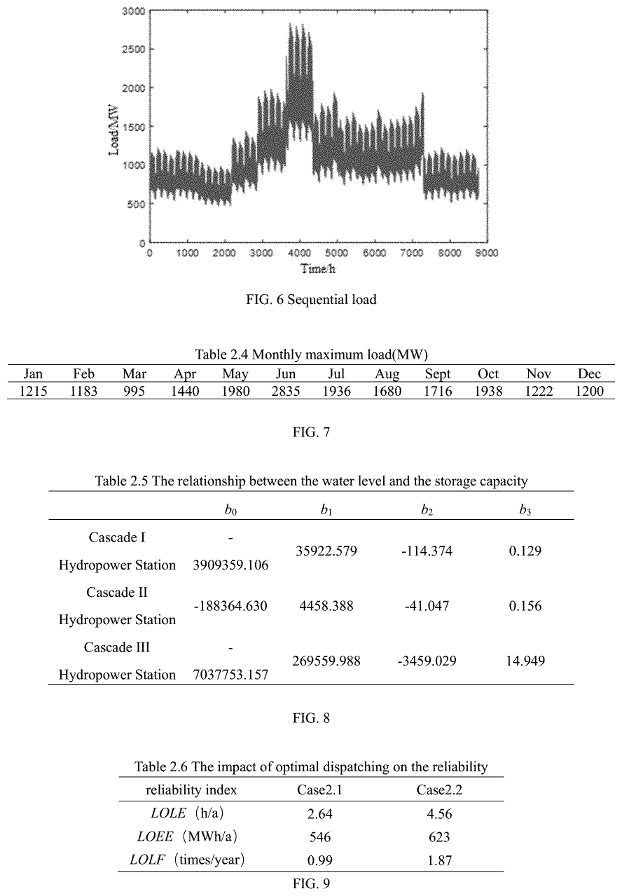

The sequential load data is shown in FIG. 6, and the monthly maximum load is shown in FIG. 7. It should be noted that, in addition to the load of the system itself, the system has external load during the normal season and the rainy season, especially greater in the rainy season. In this embodiment, the two kinds of load are both taken into account, regarded as equivalent load.

The water level and storage capacity of the reservoir are in one-to-one correspondence. The water level can be converted into the storage capacity, according to the water level-storage capacity relationship curve of each hydropower station, as shown in FIG. 8. As the initial water level in the scheduling cycle, the flood control level of each hydropower station is used. As the maximum water level, the normal storage level is used. And, as the minimum water level, the dead storage level is used.

Case2.1: Storage capacity equalization constraint at the beginning and ending of the scheduling cycle are taken into account, while considering the optimized scheduling of cascade hydropower stations.

Case2.2: Storage capacity equalization constraint at the beginning and ending of the scheduling cycle are taken into account, while not considering the optimized scheduling of cascade hydropower stations.

The calculation method and process for Case2.1 are the same as the steps S1-S7 described above. The calculation method and process for Case2.2 are as follows:

S2.1: The wind speed and runoff data within 24 is input.

S2.2: The operating strategy for Case2.2 is the same as Case2.1.First, the wind power is consumed. Then, the hydropower is consumed. Finally, the thermal power is responsible for the remaining load.

S2.3: By the sequential Monte Carlo method, the state durations of the wind power units, thermal power units and hydropower units are sampled and segmented on a 24-hour cycle.

S2.4: The output of the wind farms and the net load of the system are calculated according to the state and wind speed data of the wind power units.

S2.5: According to the runoff and load data, the water resources in the scheduling cycle are allocated, according to the load ratio, based on the storage capacity equalization constraint at the beginning and ending of the scheduling cycle. The output of the cascade hydropower stations in the scheduling cycle is calculated by:

$$\begin{matrix}{P}_{i , t} = {K}_{i} {Q}_{i , t} {H}_{i} i = 1 , 2 , 3 & ( 2.16 ) \\ {Q}_{i , t} = \frac{{L}_{t}}{{\sum }_{t = 1}^{T} {L}_{t}} \times {\sum }_{m = 1}^{i} {\sum }_{t = 1}^{T} {I}_{m , t} & ( 2.17 ) \\ {P}_{i . , t}^{max} = {K}_{i} {Q}_{i , max} {H}_{i} & ( 2.18 ) \\ {P}_{i , t}^{st} = {\sum }_{n = 1}^{{GN}_{i}} {α}_{i , t , n} {p}_{i , n}^{G} & ( 2.19 ) \\ {P}_{i , t}^{f} = min ( {P}_{i , t} , {P}_{i , t}^{max} , {P}_{i , t}^{st} ) & ( 2.20 )\end{matrix}$$

where, p_{i,n}^{G} represents the rated capacity of the n^{th} unit in the i^{th}-stage hydropower station; represents the state of the n^{th} unit in the i^{t}-stage hydropower station at the t^{th} hour; GNᵢ represents the number of units in the i^{th}-stage hydropower station; and P_{i,t}^{f} represents the actual output of the i^{th}-stage hydropower station at the t^{th} hour.

S2.6: The actual output of the cascade hydropower station calculated in the step S2.5 is compared with the net load, if the actual output is greater than the net load, the hydropower station reduces the output according to the proportion of installed capacity, and if the actual output is less than the net load, the thermal power unit is responsible for the remaining load. Finally, the hourly loss-of-load is calculated.

S2.7: The steps S2.3 to S2.6 are repeated until convergence.

The results of reliability assessment of the wind, thermal and hydropower power systems considering the optimized scheduling of the cascade hydropower stations are shown in FIG. 9. Both Case 2.1 and Case 2.2 take the storage capacity equalization constraint at the beginning and ending of the scheduling cycle into account. This constraint ensures that the water resources available for the cascade hydropower stations during the scheduling cycle are just one-day runoff. Although limiting the power generation capacity of the cascade hydropower stations, this constraint is beneficial to the long-term and sustainable operation of the cascade hydropower stations, and also ensures sufficient water resources for the implementation of other functions of the cascade hydropower stations.

It can be known from FIG. 9 that, compared with Case2.2, the reliability index LOLE is reduced by 1.92 h/a, the reliability index LOEE is reduced by 77 MWh/a, and the reliability index LOLF is reduced by 0.88 times/year in Case2.1. It is indicated that, at equal storage capacities at the beginning and ending of the scheduling cycle, by the optimized scheduling of the cascade hydropower stations, the power generation capacity of the cascade hydropower stations can be increased, thereby increasing the power generation capacity of the whole system and improving the reliability of the system. Therefore, when assessing the reliability of power systems containing cascade hydropower stations, it is necessary to take the optimized scheduling of the cascade hydropower stations into account.

The technical solutions in the embodiments of the present invention have been described in detail above, and the principles and implementations of the embodiments of the present invention have described by specific examples. The description of the above embodiments is only provided to help understand the principles of the embodiments of the present invention. Meanwhile, it may be appreciated by a person of ordinary skill in the art that, in accordance with the embodiments of the present invention, changes may be made to the specific embodiments and applications. Thus, the description shall not be interpreted as limiting the present invention.

The foregoing description of the exemplary embodiments of the present invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. A power system reliability assessment method considering optimized scheduling of cascade hydropower stations, by which the reliability of the power system is improved, comprising following steps:
S1: establishing wind, thermal and hydropower power system optimization models considering short-term optimized scheduling of the cascade hydropower stations, and calculating by a central processing unit:
S1.1: establishing an output model for the cascade hydropower stations:
(a) output function for the hydropower stations:
P_{i,t}=KᵢQ_{i,t}Hᵢ
where, Kᵢ represents an output coefficient from the i^{th}-stage hydropower station; Q_{i,t} represents the power flow of the i^{th}-stage hydropower station at the t^{th} hour; and Hᵢ represents the head of the i^{th}-stage hydropower station, which is measured by a water level meter;
(b) output constraint for the hydropower stations:
P_{i,min}≤P_{i,t}≤P_{i,max}
where, P_{i,max} and P_{i,min} represent maximum and minimal outputs of the i^{th}-stage hydropower station;
(c) power flow constraint:
Q_{i,min}≤Q_{i,t}≤Q_{i,max}
where, Q_{i,max} and Q_{i,mi} represent maximum and minimal power flows of the i^{th}-stage hydropower station;
(d) water balance constraint:
V_{i,t}=V_{i,t-1}+(I_{i,t}+Q_{i-1,t}+S_{i-1,t}−Q_{i,t}−S_{i,t})×Δt
where, V_{i,t} represents the storage capacity of the i^{th}-stage hydropower station at the t^{th}-stage hour; I_{i,t} represents the runoff into the reservoir of the i^{th}-stage hydropower station at the t^{th} hour which is measured by a flowmeter; S_{i,t} represents the spillage flow of the i^{th}-stage hydropower station at the t^{th} hour; Δt=3600 seconds;
(e) discharge flow constraint:
D_{i,min}≤S_{i,t}+Q_{i,t}≤D_{i,max}
where, D and Di,min represent maximum and minimal discharge flows allowable by the i^{th}-stage hydropower station;
(f) storage capacity constraint:
V_{i,min}≤V_{i,t}≤V_{i,max}
where, V_{i,max} and V_{i,min} represent maximum and minimal storage capacities of the i^{th}-stage hydropower station;
(g) Storage capacity equalization constraint at the beginning and ending of the scheduling cycle:
V_{i,0}=V_{i,T}
where, V_{i,0} and V_{i,T} represent storage capacities of the i^{th}-stage hydropower station at the beginning and ending of the scheduling cycle;
S1.2: output model for wind farms:
based on the principle of aerodynamics, the output power of the wind power units is in direct proportion to the third power of wind speed, then:
$$P ( v ) = \{ \begin{matrix}0 & ( v \leq {v}_{ci} ) ⋃ ( v \geq {v}_{co} ) \\ \frac{{P}_{R}}{{v}_{R}^{3} - {v}_{ci}^{3}} ( {v}^{3} - {v}_{ci}^{3} ) & {v}_{ci} \leq v \leq {v}_{R} \\ {P}_{R} & {v}_{R} \leq v \leq {v}_{co}\end{matrix}$$
where, P (v) represents the output power of the wind power units; P_{R} represents the rated power of the wind power units; v_{ci} represents the cut-in wind speed; v_{R} represents the rated wind speed; v_{co} represents the cut-out wind speed; and v represents the wind speed at high points on hubs of the wind power units, which is measured by a wind meter;
without considering the wake effect and the wind speed correlation in the wind farms, the output of the wind farms is the sum of output power of the wind power units:
$$W P ( v ) = {\sum }_{i = 1}^{{N}_{w g}} {α}_{i} {P}_{i} ( v )$$
where, WP (v) represents the output of the wind farms; N_{wg} represents the number of wind power units; and αᵢ represents the state of the wind power units, indicating the normal operation of the wind power units at αᵢ=1 and the fault of the wind power units at αᵢ=0;
S1.3: output model for the thermal power units:
TP_{j,min}≤TP_{j,t}≤TP_{j,max}
where, TP_{j,max} and TP_{j,min} represent maximum and minimal outputs of the thermal power unit j;
−rⱼ^{d}≤TP_{j,t}−TP_{j,t-1}≤rⱼ^{u}
where, rⱼ^{u} and rⱼ^{d} represent maximum ramp-ups and ramp-downs rates of the thermal power unit j;
S1.4: Optimized operation models for wind, thermal and hydropower power systems:
establishing an objective function to minimize the amount of load shed:
$$min f = {\sum }_{t = 1}^{T} {LoL}_{t}$$
where, represents the amount of load shed at the t^{th} hour; and T represents the scheduling cycle, T=24 h;
(h) loss-of-load constraint:
0≤LoLₜ≤Lₜ
where, Lₜ represents load at the t^{th} hour, which is obtained by a load monitoring system;
(i) power balance constraint:
$${\sum }_{i = 1}^{{N}_{H}} {P}_{i , t} + {\sum }_{j = 1}^{{N}_{T}} T {P}_{j , t} + {\sum }_{k = 1}^{{N}_{W}} W {P}_{k , t} = {L}_{t} + L o {L}_{t}$$
where, N_{H}, N_{T} and N_{W} represent the number of stages of cascade hydropower stations, the number of thermal power units and the number of wind farms, respectively; TP_{j,t} represents the output of the thermal power unit j at the t^{th} hour; and WP_{k,t} represents the output of the wind farm k at the t^{th} hour;
S2: monitoring the annual wind speed, runoff and load data by the wind meter, the flowmeter and the load monitoring system, and inputting the sequential wind speed, runoff and load data within 24 h;
S3: in accordance with reliability parameters of the wind power units, thermal power units and hydropower units and by the sequential Monte Carlo method, sampling the state durations of the three kinds of units and segmenting the state durations on a 24-hour cycle;
S4: calculating the sequential output of the wind farms within 24 h according to the wind speed data and the state of the wind power units;
S5: calculating, by the central processing unit, the sequential output of the cascade hydropower stations and the thermal power units with 24 h and the hourly loss-of-load, according to the state of the wind power units and the thermal power units as well as the wind, thermal and hydropower power system optimization models considering short-term optimized scheduling of the cascade hydropower stations;
S6: optimizing for 365 days according to the method described in the step S5, and calculating yearly reliability indices: loss-of-load expectation LOLE, loss-of-energy expectation LOEE and loss-of-load frequency LOLF; and
S7: determining convergence or not according to the equation in 3, and if not, returning to the step S3 and repeating the steps S3 to S7 until convergence.

2. The power system reliability assessment method considering optimized scheduling of cascade hydropower stations according to claim 1, wherein, in the step S1.2, when the wind speed v is between V_{ci} and V_{R}, the output power of the wind power units can be approximately linear to the wind speed:
$$P ( v ) = \{ \begin{matrix}0 & ( v \leq {v}_{ci} ) ⋃ ( v \geq {v}_{co} ) \\ {P}_{R} \frac{v - {v}_{co}}{{v}_{R} - {v}_{ci}} & {v}_{ci} \leq v \leq {v}_{R} \\ {P}_{R} & {v}_{R} \leq v \leq {v}_{co}\end{matrix} .$$

3. The power system reliability assessment method considering optimized scheduling of cascade hydropower stations according to claim 1, wherein, in the step S7, the determination of convergence or not is performed by determining whether a coefficient of variance 67 is less than or equal to a set value, the coefficient of variance being expressed by:
$$δ = \frac{S t d ( L O E E )}{\sqrt{{N}_{s}} \times mean ( LOE E )}$$
where, std(LOEE) and mean(LOEE) represent standard deviation and mean of LOEE; and Nₛ represents the number of simulated years.
